(19) United States
(12) Patent Application Publication
(10) Pub. No.: US 2018/0156031 A1
(43) Pub. Date: Jun. 7, 2018

(54) SCALABLE COMMUNICATION SYSTEM FOR HYDROCARBON WELLS

(71) Applicant: Halliburton Energy Services, Inc., Houston, TX (US)

(72) Inventors: Thanh T. Tran, Houston, TX (US); William Schaecher, Houston, TX (US); Yumin Zhang, Allen, TX (US); Daniel Stark, Houston, TX (US)

(21) Appl. No.: 15/572,978

(22) PCT Filed: Sep. 22, 2015
(86) PCT No.: PCT/US2015/051493

§ 371 Date: Nov. 9, 2017

(51) Int. Cl. E21B 47/12; G01V 11/00

(52) U.S. Cl. CPC E21B 47/123; G01V 11/002

(57) ABSTRACT

A scalable communication system for data transmission in oil and gas well applications. The communication system includes a high-speed fiber optic line connecting a surface module to a downhole module. The downhole module is further connected to a tool bus which in turn is connected to one or more tool modules. Each tool module permits communication of data to and/or from one or more downhole tools. A broadband signal comprising multiple channels may be used to transmit data to and from the tool modules.

### BACKGROUND

Modern drilling, completion, and production techniques used in the oil and gas industry generally require transmission of significant amounts of data between surface and downhole equipment. Such data serves many purposes including, but not limited to, monitoring and controlling downhole equipment and collecting information related to downhole conditions and formation properties.

As downhole equipment becomes more sophisticated, it incorporates more sensors, actuators, and control systems, each requiring or producing increasing amounts of data. This increased data requirement necessarily requires a data transmission system with speed and capacity to facilitate communication between surface and downhole equipment. Compounding the issue of increased data requirements is the ever increasing depths of modern wells, which require longer data transmission lines that are more susceptible to attenuation and data loss.

In light of the above, a communication system for use in oil and gas wells and having increased data capacity that is less susceptible to attenuation over long distances is desirable. It is further desirable that such a communication system be readily scalable to accommodate additional equipment.

### BRIEF DESCRIPTION OF THE DRAWINGS

A more complete understanding of the present embodiments and their advantages may be acquired by referring to the following description taken in conjunction with the accompanying drawings, in which like reference numbers indicate like features.

FIG. 1 is a schematic view of a communication system according to a first embodiment;

FIG. 2 is a schematic view of a communication system according to a second embodiment;

FIG. 3 is a graph depicting a broadband signal, the broadband signal comprising a series of channels;

FIG. 4 is a schematic view of a communication system according to a third embodiment; and

FIGS. 5A-C are schematic views of communications systems according to other embodiments having auxiliary communication paths.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to communication of data in oil and gas well applications. More specifically, the present disclosure relates to a scalable communications system for transmitting data between surface and downhole equipment.

Illustrative embodiments of the present invention are described in detail herein. In the interest of clarity, not all features of an actual implementation may be described in this specification. It will of course be appreciated that in the development of any such actual embodiment, numerous implementation specific decisions must be made to achieve the specific implementation goals, which will vary from one implementation to another. Moreover, it will be appreciated that such a development effort might be complex and time consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processor or processing resource such as a central processing unit (CPU) or hardware or software control logic, ROM, and/or other types of nonvolatile memory. As used herein, a processor may comprise a microprocessor, a microcontroller, a digital signal processor (DSP), an application specific integrated circuit (ASIC), or any other digital or analog circuitry configured to interpret and/or execute program instructions and/or process data for the associated tool or sensor. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For purposes of this disclosure, “communication” and its related terms (“communicating”, “communicate”, “communicates”, etc.) include data transmissions that occur directly between the source of the data transmission and the desired destination of the data transmission, as would occur between two directly connected devices. These terms also include indirect data transmissions between two devices. For example, a data transmission originating at a first device and sent over a network via switches, relays, and other devices to a second device is “communicated” between the first and the second device. Data transmission between the first and the second device may also require processing of the data. For example, data corresponding to a sensor measurement may begin as an analog sensor reading at a first device but may require amplification, filtering, analog-to-digital conversion, modulation, demodulation, digital-to-analog conversion, or other processing to be properly transmitted to the second device. Accordingly, even though the original analog sensor reading is not received by the second device, the corresponding data contained in the analog sensor reading is “communicated” between the first device and the second device.

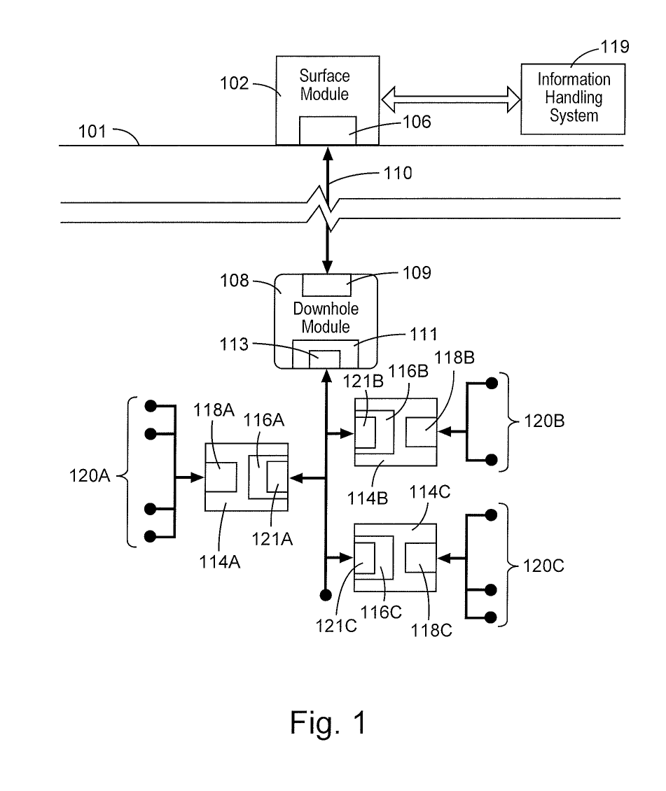

FIG. 1 is a schematic view of one embodiment of a communications system in accordance with this disclosure. A surface module 102 comprising a surface fiber optic modem 106, may be located on the surface 101 of a hydrocarbon well. Communications may be exchanged between the surface module 102 and a downhole fiber optic modem 109 via a fiber optic cable 110. The downhole module 108 is communicatively coupled to the downhole fiber optic modem 109. As depicted in FIG. 1, this coupling may be achieved in certain embodiments by integrating the downhole fiber optic modem 109 into the downhole module 108. In other embodiments, the downhole fiber optic modem 109 may be separate from the downhole module 108 and selectively attachable to the downhole module 108.

The downhole module 108 may include a tool bus interface 111. The tool bus interface 111 may communicatively couple the downhole module 108 to a tool bus 112. One or more tool modules, for example tool modules 114A, 114B, 114C, may be connected to the tool bus 112. As exemplified by tool module 114A, each tool module may include a tool interface 116A for communicatively coupling the tool module 114A to the tool bus 112, one or more sensors 120A, and a hub 118A to collect measurements and data generated by the sensors 120A. Communication systems in accordance with this disclosure may be scalable and, as a result, are not limited to any particular number of surface modules, downhole modules, tool modules, and pieces of downhole equipment.

Tool modules may have a one-to-one relationship with downhole tools (i.e., each downhole tool has its own tool module), but the possible ratios of tool modules to downhole equipment are not so limited. A single downhole tool may be assigned multiple tool modules or multiple downhole tools may be assigned a single tool module.

Communication systems in accordance with this disclosure are suitable for use with any downhole tools capable of producing and/or receiving data. Communication between tool modules and the surface module may be uni-directional or bi-directional, depending on the data needs of the downhole tool. Examples of downhole tools include, but are not limited to, MWD tools, LWD tools, dielectric logging tools, motors, valves, sleeves, packers, perforating guns, downhole testing systems, acoustic telemetry systems, shut-in tools, and downhole sensors and sensor arrays.

During operation, data may be transferred between the surface module 102 and one or more of the downhole module 108 and tool modules 114A, 114B, 114C. For purposes of this disclosure, “upstream” data transmission refers to data transmissions originating downhole and received at the surface. In contrast, “downstream” data transmission refers to data originating at the surface and received downhole. Although this disclosure focuses on communication systems capable of both upstream and downstream communications, communication systems in accordance with this disclosure may also communicate exclusively in the upstream or downstream directions.

During upstream data transmission, data may be generated by one of the downhole module 108 and the tool modules 114A, 114B, 114C. For example, referring to tool module 114A, the data may originate as measurement data generated by sensor 120A and collected by hub 118A. In addition to sensor measurements, additional data transmitted upstream may include tool status information, commands, control signals, tool “heartbeat” signals, and/or any other data useful for monitoring and controlling downhole operations. The measurement signal may be processed to create a tool bus signal in a format suitable for transmission over the tool bus 112. The tool bus signal may then be placed on the tool bus 112 and communicated over the tool bus 112 to the downhole module 108. The downhole module 108 receives the tool bus signal via the tool bus interface 111. Fiber optic modulation may be applied to the tool bus signal (or a processed version of the tool bus signal) by the downhole fiber optic modem 109 to produce a fiber optic signal that may be placed on the fiber optic cable 110 for transmission to the surface module 102. The surface fiber optic modem 106 demodulates the fiber optic signal permitting extraction of the measurement data. The measurement may then be made available to an information handling system 119 for uses including but not limited to transmitting the data to a second remote information handling system, logging or storing the data in a database, analyzing the data using automated analysis tools, displaying the data to an operator as part of a human-machine interface (HMI), and using the data as feedback for an automated control system.

In certain embodiments, multiple tool modules, such as tool modules 114A, 114B, 114C, may communicate simultaneously over the tool bus 112. One method of simultaneously communicating data from multiple tool modules is to assign each tool module a channel or band of a broadband signal. To do so, the tool bus interface of the tool module may include a tool modem (for example, tool modem 116A of tool module 114A) capable of modulating data to generate a data signal at a channel frequency corresponding to the tool module. Each data signal generated by tool modules in this way may be placed on the tool bus simultaneously and received by the to the downhole module 108 as a combined data signal. The downhole module 108 may then process the combined data signal as necessary for communication over the fiber optic cable 110 to the surface module 102.

During downstream data transmission, the process described above for upstream data transmission is generally reversed. Data may be sent downstream by the surface module 102 over the fiber optic cable 110. Specifically, data to be sent downstream is modulated by the surface fiber optic modem 106 to generate a fiber optic signal. The fiber optic signal is placed on the fiber optic cable 110 and received by the downhole fiber optic modem 109, which demodulates the fiber optic signal. The downhole module 108 then processes the demodulated fiber optic signal to generate a tool bus signal suitable for transmission over the tool bus 112. The tool bus signal is placed on the tool bus 112 via the tool bus interface 111 and is received by the intended tool module. For purposes of this example, the intended tool module is tool module 114A. The tool bus signal is received by the tool module 114A via the tool interface 116A. The tool bus signal may then be processed converted as necessary to extract the data. Similar to upstream transmission, downstream data transmission may involve simultaneous transmission of data over multiple channels of a broadband signal.

The tool bus 112 may comprise any cable or wire suitable for transmitting data between the tool modules 114A, 114B, 114C, and the downhole module 108 including, but not limited to, copper, coaxial, twinax, and fiber optic cable. The tool bus interface 111 of the downhole module 108 may include a downhole module modem 113 for modulating and demodulating signals sent over the tool bus. Similarly tool modules, 114A, 114B, 114C may also include tool modems 121A, 121B, 121C. Each of the downhole module modem 113 and tool modems 121A, 121B, 121C, may permit communication using standard communication protocols and specifications. For example, in embodiments in which the tool bus comprises coaxial cable, each of the downhole module modem 113 and tool modems 121A, 121B, 121C may be data over cable service interface specification (DOCSIS) modems.

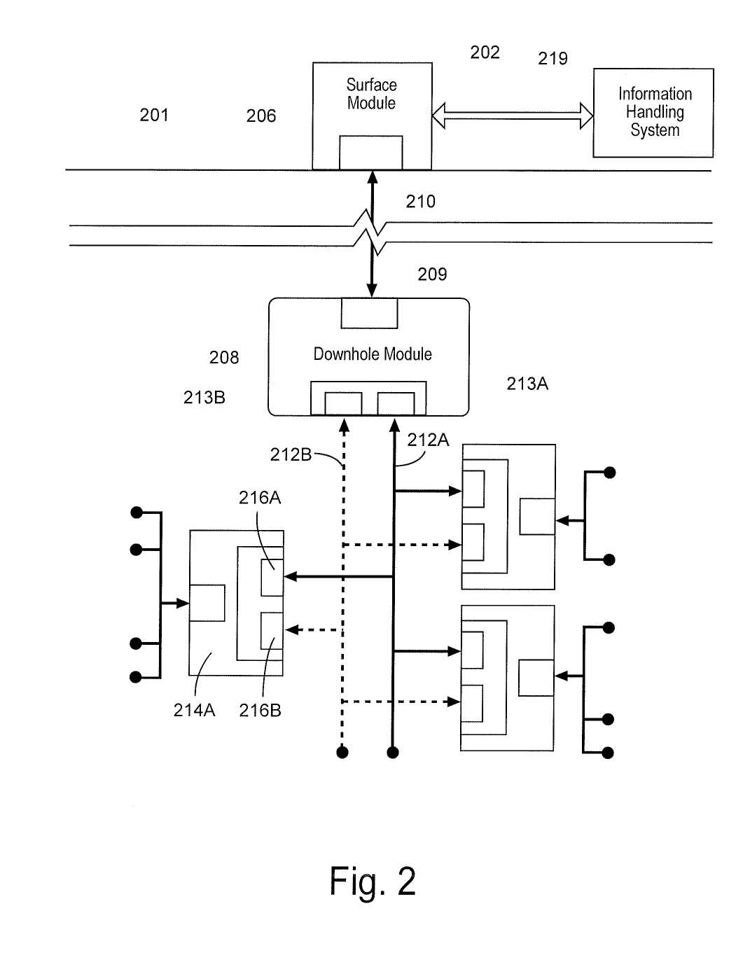

In certain embodiments, multiple tool buses may be implemented. FIG. 2 includes a surface module 202 comprising a surface fiber optic modem 206 and located on the surface 201 of a hydrocarbon well. Communications may be exchanged between the surface module 202 and a downhole fiber optic modem 209 via a fiber optic cable 210. The downhole module 208 is communicatively coupled to the downhole fiber optic modem 209. As depicted in FIG. 2, a communications system in accordance with this disclosure may include a first tool bus 212A and a second tool bus 212B. The first tool bus 212A and the second tool bus 212B may comprise the same transmission medium. For example, both the first tool bus 212A and the second tool bus 212B may comprise coaxial cables. In other embodiments, the first tool bus 212A and the second tool bus 212B may comprise different transmission media. For example, the first tool bus 212A may comprise coaxial cable and conform to DOCSIS, while the second tool bus 212B may comprise a different cable, such as twinax cable, and conform to a different communication standard, such as MIL-STD-1553. If multiple tool buses are used, the tool interface for each tool module and the tool bus interface of the downhole module may comprise multiple modems for facilitating data transmission over multiple tool buses. In FIG. 2, for example, downhole module 208 includes a first downhole module modem 213A for communication over the first tool bus 212A and a second downhole module modem 213B for communication over the second tool bus 212B. Similarly, tool module 214A comprises a first tool modem 216A and a second tool modem 216B for communication over the first tool bus 212A and the second tool bus 212B, respectively.

Data transmitted over communication systems in accordance with this disclosure may be modulated for transmission between various devices in the system. The present disclosure is not limited to any particular modulation type, but by way of example, data transmitted through the system may be modulated using at least one of quadrature amplitude modulation (QAM), quadrature phase shift keying (QPSK), pulse width modulation (PWM), and pulse amplitude modulation (PAM). Transmitted data may also be encoding using techniques including but not limited to Manchester coding and its variants.

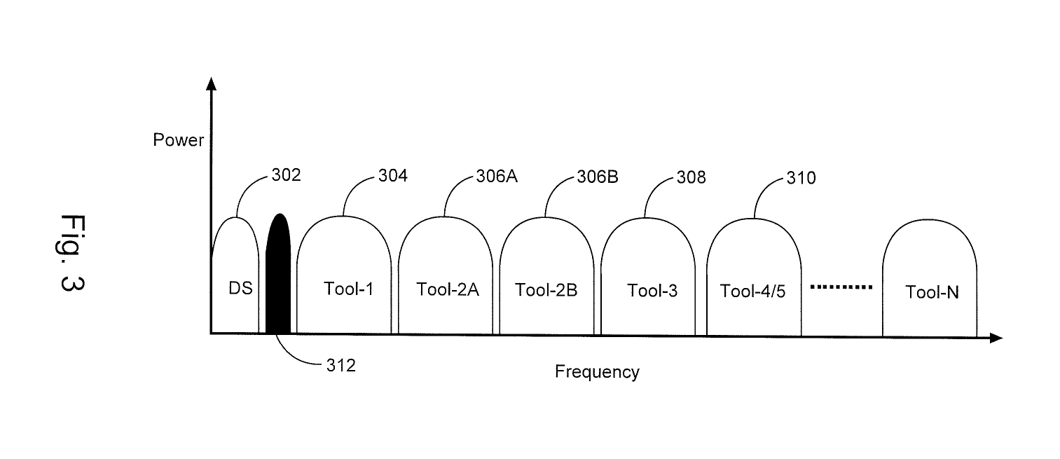

Data may be transmitted over communication systems in accordance with this disclosure using a broadband signal divided into channels. Each channel may correspond to data sent between any of the surface, downhole, and tool modules. Any number of surface, downhole, and tool modules may be configured to receive data from a particular channel. Similarly, two or more surface, downhole, and tool modules may be permitted to send data over a single channel. FIG. 3 is a graph depicting one example of a broadband signal for transmission over a communication system in accordance with this disclosure. The broadband signal may comprise multiple channels. Channels may have equal or differing bandwidths. For example, downstream (DS) channel 302 is shown as occupying a narrower band than Tool-1 channel 304, while Tool-1 channel 304 has the same bandwidth as Tool-3 channel 308. Uneven bandwidth distribution may be suitable for use when certain channels require less data transmission capacity. For example, DS channel 302 may only transmit basic control and status signals and therefore would require significantly less bandwidth than a channel dedicated to transmitting a stream of data from one or more sensors. As previously mentioned, multiple channels may be assigned to a module. For example, Tool-2A channel 306A and Tool-2B channel 306B each correspond to the same tool module, i.e., Tool-2. Similarly, a channel may be assigned to multiple tool modules. For example, Tool-4/5 channel 308 is a single channel dedicated to data transmission to and from each of tool modules Tool-4 and Tool-5. In addition to data channels, the broadband signal may comprise one or more reserve bands, such as reserve band 312, which remain unused to ensure separation between channels. For example, reserve band 312 is depicted as separating DS channel 302 from Tool-1 channel 304. The broadband signal may also comprise one or more pilot or training bands (not depicted). A pilot or training band may be used to carry a pilot signal for supervisory, control, equalization, continuity, synchronization, reference and other purposes.

Routing of data within communication systems in accordance with this disclosure may be conducted using various routing techniques. For example, routing may be achieved by assigning numerical addresses, such as internet protocol (IP) addresses, to each module and transmitting data using a protocol that routing equipment, such as switches and routers, can interpret to direct the data. Alternatively, a device identifier may be assigned to each module and inserted into the data to delimit data within a data stream and to indicate the source and/or destination of the delimited data. As yet another example, data may be routed by dedicating channels of a broadband signal to communications between particular modules. In such embodiments, data on a particular channel is known to be sent or received by only modules assigned to the channel.

One or more routing techniques may be combined in order to route data within the system. For example, in one embodiment, a broadband signal may be divided into a single downstream channel and multiple upstream channels. The downstream channel may be used to transmit control and status information between a surface module and all downhole equipment in a single data stream. To separate data intended for different modules, device identifiers may be inserted into the data stream to delimit and identify data intended for different pieces of downhole equipment. Each module that receives the data stream may be further configured to recognize its assigned appropriate device identified and to extract the corresponding data from the data stream. The upstream channels, on the other hand, may be used exclusively for transmitting data from the tool modules, with each upstream channel corresponding to a specific tool module. Because each of the tool channels is dedicated to a specific tool module, any data received over a given channel is known to have originated from and can be associated with the specific tool module.

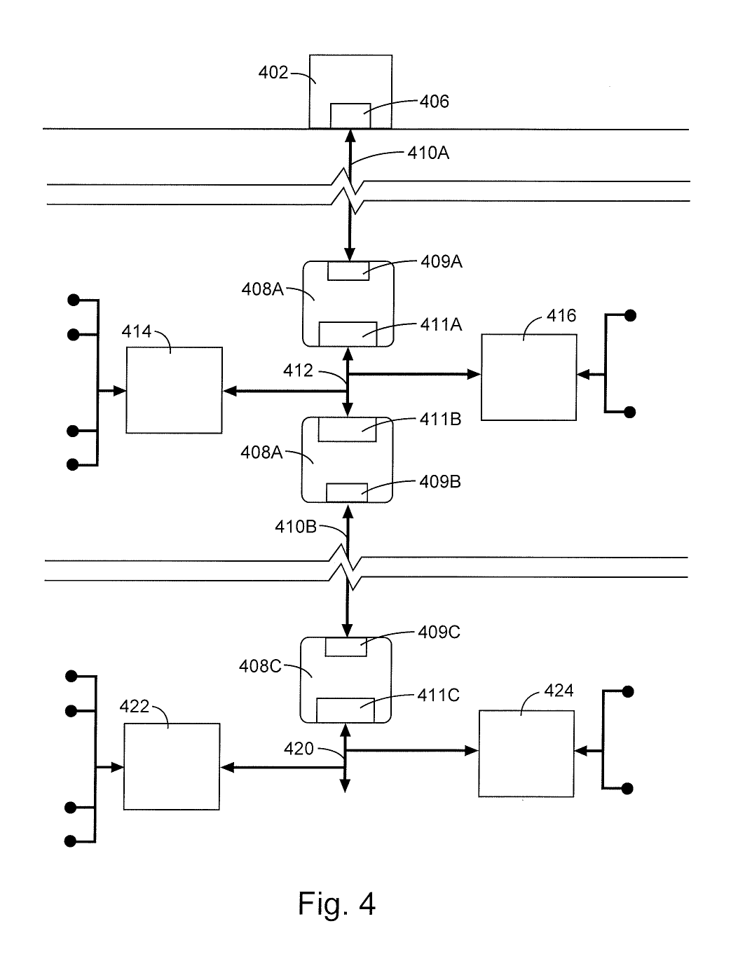

FIG. 4 is a schematic of another communication system in accordance with this disclosure. To the extent previous embodiments discussed in this disclosure were limited to a single fiber optic cable and a single downhole module, FIG. 4 is intended to illustrate that in other embodiments, multiple fiber optic cable runs and multiple downhole modules may be chained together. As depicted in FIG. 4, a surface module 402 comprising a surface fiber optic modem 406, may be located on the surface of a hydrocarbon well. Communications may be exchanged between the surface module 402 and a first downhole module 408A via a first fiber optic cable 410A. The first downhole module 408A may comprise a first downhole fiber optic modem 409A and a first tool bus interface 411A and operate to convert data between formats suitable for transmission over the first fiber optic cable 410A and the first tool bus 412. The first tool bus interface 411A may communicatively couple the downhole module 408A to a first tool bus 412. One or more tool modules, for example tool modules 414 and 416 may be connected to the first tool bus 412.

Further connected to the first tool bus 412A may be a second downhole module 408B comprising a second tool bus interface 412B and a second downhole fiber optic modem 409B. The second downhole module 408B may be connected to a second fiber optic cable 410B and may operate to convert data from a format suitable for transmission over the first tool bus 412 to one suitable for transmission over the second fiber optic cable 410B. The second fiber optic cable 410B may link the second downhole module 408B to a third downhole module 408C comprising a third downhole fiber optic modem 409C and a third tool bus interface 411C.

The third downhole module 408C may in turn be connected to a second tool bus 420 via a third tool bus interface 411C. Further connected to the second tool bus 420 may be additional tool modules 422 and 424. Data transmission in the embodiment of FIG. 4 may occur in a similar manner as previously discussed in this disclosure but with the additional steps of converting the data between formats suitable for transmission over fiber optic cable and formats suitable for transmission over a tool bus as necessary.

As depicted in the embodiment of FIG. 4, surface module 402 and downhole modules 408A, 408B, and 408C are connected along a primary communication path comprising the first fiber optic cable 410A, the second fiber optic cable 410B, the first tool bus 412 and the second tool bus 420. In the event one of downhole modules 408A, 408B, and 408C failed, communication along the communication path may be disrupted. Accordingly, each of downhole module 408A, 408B, and 408C may be configured to operate in a pass-through mode that would still permit data to be transmitted along the primary communication path in the event that a given downhole module were to fail.

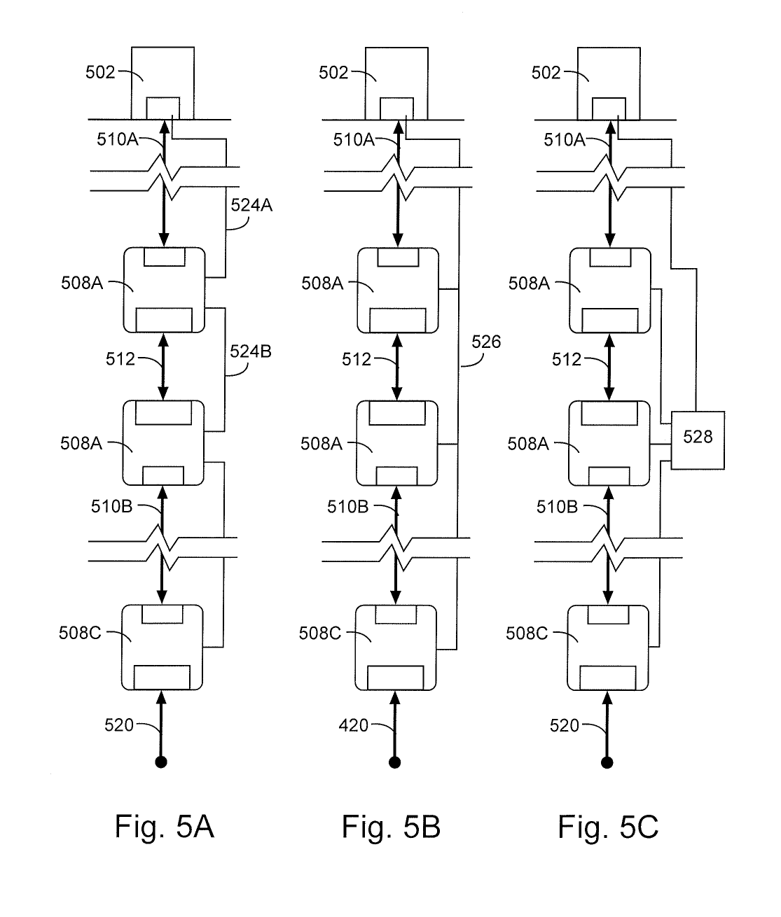

In other embodiments, an auxiliary communication path may be implemented. FIGS. 5A, 5B, and 5C depict three embodiments with auxiliary communication paths. Similar to FIG. 4, communication in the embodiments of FIGS. 5A-C occurs primarily over a primary communication path comprising a first fiber optic cable 510A, a second fiber optic cable 510B, a first tool bus 512, and a second tool bus 520. For purposes of clarity, tool modules are omitted from FIGS. 5A-C. As an alternative to or in addition to communicating over the primary communication path, communication may occur over the auxiliary communication path.

The auxiliary communication path is not limited to any particular transmission medium. For example, the auxiliary communication path may comprise copper wire, coaxial cable, twinax cable, and fiber optic cable. Communication over the auxiliary communication path may be accomplished using any suitable communication protocol or data transmission method, including those previously discussed in this disclosure. Downhole modules configured to communicate over the auxiliary communication path may include additional components, such as modems, to facilitate communication over the auxiliary communication path.

FIG. 5A depicts a first embodiment in which the auxiliary communication path connects each of the downhole modules 508A, 508B, and 508C in series. Specifically, each of surface module 502 and downhole modules 508A, 508B, and 508C are connected in series by lines 524A, 524B, and 524C. As a result, the auxiliary communication path operates as a redundant communication path for the primary communication path. In another embodiment, as depicted in FIG. 5B, the auxiliary communication pathway may be implemented as a communication bus 526 to which surface module 502 and downhole modules 508A, 508B, and 508C are each connected. In a third embodiment, depicted in FIG. 5C, the auxiliary communication path may be implemented as a switched network in which surface module 502 and downhole modules 508A, 508B, and 508C communicate via a switch 528.

Although numerous characteristics and advantages of embodiments of the present invention have been set forth in the foregoing description and accompanying figures, this description is illustrative only. Changes to details regarding structure and arrangement that are not specifically included in this description may nevertheless be within the full extent indicated by the claims.

What is claimed is:

1. A communication system, comprising:
a surface module comprising a first fiber optic modem;
a second fiber optic modem communicatively coupled to the first fiber optic modem;
a downhole module communicatively coupled to the second fiber optic modem; and
a tool module having a tool interface configured to receive data from at least a first tool sensor,
wherein the downhole module and the tool module are communicatively coupled via the tool interface by a tool bus.

2. The communication system of claim 1, further comprising a second tool module comprising a second tool interface, the second tool module configured to receive data from at least a second tool sensor; wherein the downhole module and the second tool module are communicatively coupled via the second tool interface.

3. The communication system of claim 2, wherein:
data corresponding to the tool module is transmitted over a first set of one or more data channels; and
data corresponding to the second tool module is transmitted over a second set of one of more data channels.

4. The communication system of claim 1, wherein the tool bus comprises a transmission medium selected from the group of copper wire, coaxial cable, twinax cable, and fiber optic cable.

5. The communication system of claim 1, wherein the tool module further comprises a data over cable service interface specification (DOCSIS) modem.

6. The communication system of claim 1, further comprising a second tool bus, wherein the second tool bus also connects the downhole module to the tool module via the tool interface.

7. The communication system of claim 6, wherein data communicated from the tool module to the downhole module travels over the first tool bus and data communicated from the downhole module to the tool module travels over the second data bus.

8. The communication system of claim 1, wherein at least one of first fiber optic modem and the second fiber optic modem is configured to transmit data using at least one of quadrature amplitude modulation (QAM) quadrature phase shift keying (QPSK), pulse amplitude modulation (PAM), pulse width modulation (PWM), and Manchester coding.

9. The communication system of claim 1, wherein the tool module is assigned a device identifier and data is routed through the communication system based on the device identifier.

10. The communication system of claim 1, wherein the tool module is assigned at least one frequency band such that data corresponding to the tool module is transmitted in the at least one frequency band.

11. The communication system of claim 1, wherein the tool module comprises the second fiber optic modem.

12. The communication system of claim 1, further comprising:
a second downhole module communicatively coupled to the tool bus;
a third fiber optic modem communicatively coupled to the second downhole module;
a fourth fiber optic modem, wherein the fourth fiber optic modem and the third fiber optic modem are communicatively coupled by a second fiber optic cable;
a third downhole module communicatively coupled to the fourth fiber optic modem;
a second tool module having a second tool interface, the second tool module configured to receive data from at least a second tool sensor; and
wherein the third downhole module and the second tool module are communicatively coupled via the second tool module by a second tool bus.

13. The communication system of claim 12, wherein at least two of the surface module, the first downhole module, the second downhole module, and the third downhole module may also transmit data over an auxiliary communication path.

14. A method of communicating with downhole tools over a communication system comprising:
generating data at one of a surface module comprising a first fiber optic modem and a downhole tool comprising a tool module, the tool module further comprising a tool interface;
transmitting the data between the first fiber optic modem and a second fiber optic modem via a fiber optic cable; and
transmitting the data between the second fiber optic modem and the tool interface over a tool bus.

15. The method of claim 14, further comprising
generating second data at one of the surface module and a second downhole tool, the second downhole tool comprising a second tool module, the second tool module further comprising a second tool interface;
transmitting the second data between the first fiber optic modem and the second fiber optic modem via the fiber optic cable; and
transmitting the second data between the second fiber optic modem and the second tool interface over the tool bus.

16. The method of claim 15, wherein
the data is transmitted over a first set of one or more data channels corresponding to the tool module; and
the second data is transmitted over a second set of one of more data channels corresponding to the second tool module.

17. The method of claim 14, wherein the tool bus comprises a transmission medium selected from the group of copper wire, coaxial cable, twinax cable, and fiber optic cable.

18. The method of claim 14, wherein
data transmitted from the tool module to the second fiber optic modem travels over the tool bus; and
data transmitted from the second fiber optic modem to the tool module travels over a second tool bus.

19. The method of claim 14, wherein the data is modulated by one of the first fiber optic modem and the second fiber optic modem using at least one of quadrature amplitude modulation (QAM) quadrature phase shift keying (QPSK), pulse amplitude modulation (PAM), pulse width modulation (PWM), and Manchester coding.

20. The method of claim 14, wherein the tool module is assigned at least one frequency band such that data corresponding to the tool module is transmitted in the at least one frequency band.
